(19) United States
(12) Patent Application Publication
(10) Pub. No.: US 2011/0024343 A1
(43) Pub. Date: Feb. 3, 2011

(54) METHOD AND DEVICE FOR CONNECTING FILTER CARTRIDGE TO FILTER COVER BY USING INTERMEDIARY ELEMENT

(76) Inventor: Yuqiang Zhou, Guangdong (CN)

Correspondence Address: DAVID AND RAYMOND PATENT FIRM, 108 N. YNEZ AVE., SUITE 128, MONTEREY PARK, CA, 91754, US

(21) Appl. No.: 12/736,200

(22) PCT Filed: Feb. 12, 2009
(86) PCT No.: PCT/CN2009/070402

§ 371 Date: Sep. 17, 2010

(30) Foreign Application Priority Data
Mar. 17, 2008 (CN) 200810065582.6

(51) Int. Cl. B01D 35/30; B23P 17/04

(52) U.S. Cl. 210/232; 29/525.01

(57) ABSTRACT

A method of connecting filter cartridge 30 with filter cover 10 by using an intermediary element 20, wherein the intermediary element 20 includes a filter element retainer 25, an internal outlet connection 26 and a support 23. A first fastener A 22 is mounted at edge of the support 23, and a second fastener B 32 is fixed on an internal wall at the top of the filter cartridge 30. By means of fastening fastener A 22 to fastener B 32, the middleware 20 is firmly combined with the filter cartridge 30. A water outlet passage 16 disposed in the filter cover 10 is matched to the internal outlet connection 26. By connecting screw A 28 on the internal outlet connection 26 with screw B 18 on the water outlet passage 16, the intermediary element 20 is firmly fixed to the filter cover 10.

### BACKGROUND OF THE PRESENT INVENTION

1. Field of Invention

The present invention relates to a filter device and water purifier, and more particularly to a connection structure between a filter cover and a filter cartridge of a filter or water purifier, especially by means of an intermediary element that connects the filter cover with the filter cartridge while filtering fluid, and the method thereof.

2. Description of Related Arts

An existing filter device, such as a water purifying device, generally comprises the cover and the cartridge directly connected with each other by providing threads on the connecting portions of the cover and the cartridge respectively and then tightly screwing the cover with the cartridge. For example, first and second threaded portions are pre-formed at the cover and the cartridge respectively, such that the cover can be rotatably screwed with the cartridge via the first and second thread portions.

It is obvious that the above connection method can satisfy the connection strength requirement.

For example, the Chinese Utility Model Patent No. 92237985.8 discloses a portable mineralized and magnetized filter device for water faucet, wherein the cover and the cartridge there of are connected by the connection structure mentioned above.

Also, the Chinese Utility Model Patent No. 03204192.6 discloses a filter device, wherein the cover and the cartridge thereof are also connected by such connection structure mentioned above.

However, this threaded structure still has the following shortcomings:

1. The connecting portions of the cover and the cartridge of the filter device generally have bigger diameters, 80 mm or more. Therefore, the first and second threaded portions are pre-formed at the cover and the cartridge must be correspondingly configured to match with the diameters of the cover and the cartridge. In other words, the thread molding to pre-form the first and second threaded portions at the cover and cartridge must match with the size of the cover and cartridge correspondingly. Therefore, the material and manufacturing costs of the filter device with the threaded structure are relatively high, as almost 30% of the entire cost of the filter device.

2. There are generally two different sizes of core filter in the market for use in the filter cartridge, wherein one of the sizes of the filter is 10 inch long, i.e., 254 mm, while another one is 250 mm. In other words, it is always a hard time for the user to distinguish the two filters with only 4 mm difference, and it is almost non-distinguishable to human eyes.

After the core filter is placed into the filter cartridge, the filter cover is then covered and fastened with the filter cartridge via the threaded structure. Practically, people are unable to observe and determine whether the core filter is tightly pressed in position by the upper filter retainer. In other words, if the filter is installed in an improper way or a wrong core filter is installed, the filter device will discharge water without any filtering that violates the whole meaning of using a filter device.

### SUMMARY OF THE PRESENT INVENTION

The invention is advantageous in that it provides a connection arrangement and method of a filter device or water purifier device by means of an intermediary element to overcome the shortcomings of the conventional filters, including its high production costs and the non-observable problem during its installation procedure.

Another advantage of the invention is to provide a filter device or water purifier device, wherein the contacting portions of its filter cover and filter cartridge are sealed by a sealing ring under a connecting pressure provided by an intermediary element.

Accordingly, the intermediary element is first to assembled with a filter cartridge that is easily disassembled for changing the core filter. The intermediary element and the filter cartridge are fastened in position after assembled where the intermediary element has a sufficient mechanical strength to resist a predetermined pulling force.

The intermediary element has a threaded outlet end for collecting filtered water. The filter cover has a out-flowing passage for guiding the purified water, wherein the flowing-out passage and a connection portion of the outlet end of the intermediary element are provided with threads for screwing with each other to form a passage for purified water and to connect the filter cover with the filter cartridge.

In which, the out-flowing passage and the filter cover are connected with sufficient mechanical connection strength.

According to the present invention, the filter cover and the filter cartridge are connected by the intermediary element. Since the diameter size of the out-flowing passage is smaller than that of the filter cover, the manufacturing cost of the filter device incorporating with the connection configuration, i.e. the first and second threaded portions, will be substantially reduced at least 30%. In addition, when the intermediary element is coupled at the filter cartridge, the upper filter retainer is biased against an upper end of the core filter to retain the core filter in the filter cartridge. In other words, the user can notify whether the upper filter retainer being directly pressed enough to the core filter or not. If not, the filter should be changed. Thereby, the product quality of the present invention could be guaranteed.

Additional advantages and features of the invention will become apparent from the description which follows, and may be realized by means of the instrumentalities and combinations particular point out in the appended claims.

According to the present invention, the foregoing and other objects and advantages are attained by providing a method of coupling a filter cover with a filter cartridge to enclose a core filter therewithin, comprising the following steps.

(1) Provide an intermediary element which comprises an upper filter retainer, an internal outlet connector, and a support positioned between the upper filter retainer and the internal outlet connector, wherein a fluid passage is formed and is extended from the upper filter retainer to the internal outlet connector.

(2) Provide one or more first fasteners at a peripheral edge of the support and one or more corresponding second fasteners at an inner wall of the filter cartridge at the upper opening portion thereof, wherein the first fasteners and the second fasteners are fastened with each other to firmly couple the intermediary element at the filter cartridge at a position that a retaining edge of the upper filter retainer is biased against an upper end of the core filter to retain the core filter in the filter cartridge.

(3) Configure a first threaded portion at an outlet end of the internal outlet connector.

(4) Configure an out-flowing passage being extended from the filter cover at a position that the out-flowing passage is coaxially aligned with the outlet end of the internal outlet connector, wherein the out-flowing passage has a second threaded portion formed at an inlet end thereof to detachably engage with the first threaded portion at the outlet end of the internal outlet connector so as to securely couple the filter cover with the intermediary element.

Accordingly, when the first threaded portion is an inner threaded portion, second threaded portions is an outer threaded portions correspondingly. When the first threaded portion is an outer threaded portion, the second threaded portion is an inner threaded portion correspondingly.

Accordingly, in the step (4), an opposed end of the out-flowing passage is integrated with the filter cover to form an external outlet joint.

Accordingly, in the step (2), the first and second fasteners are selected from the group consisting of screw connection and locking with plug and groove connection.

In accordance with another aspect of the invention, the present invention comprises a filter device comprising a filter cartridge for receiving a core filter therein; a filter cover which comprises an out-flowing passage being extended from the filter cover; and an intermediary element for securely coupling the filter cover with the filter cartridge. The intermediary element comprises, an upper filter retainer, an internal outlet connector, and a support integrally formed between the upper filter retainer and the internal outlet connector, wherein a fluid passage is formed and is extended from the upper filter retainer to the internal outlet connector.

The intermediary element further has one or more first fasteners provided at a peripheral edge of the support, and one or more corresponding second fasteners provided at an inner wall of the filter cartridge at the upper opening portion thereof, wherein the first fasteners and the second fasteners are fastened with each other to firmly couple the intermediary element at the filter cartridge.

The intermediary element further has a first threaded portion provided at an outlet end of the internal outlet connector, and a second threaded portion formed at an inlet end of the out-flowing passage, wherein the out-flowing passage is extended from the filter cover at a position that the out-flowing passage is coaxially aligned with the outlet end of the internal outlet connector, wherein the second threaded portion is detachably engage with the first threaded portion at the outlet end of the internal outlet connector to securely couple the filter cover with the intermediary element.

Accordingly, the first fasteners and the second fasteners are fastened with each other to firmly couple the intermediary element at the filter cartridge at a position that a retaining edge of the upper filter retainer is biased against an upper end of the core filter to retain the core filter in the filter cartridge.

Accordingly, an opposed end of the out-flowing passage is integrated with the filter cover to form an external outlet joint.

Accordingly, the first and second fasteners can be screw connection or locking with plug and groove connection.

According to the preferred embodiment, the intermediary element can substantially reduce the overall manufacturing material and cost of the filter device. During the installation of the intermediary element, the user can determined whether the core filter being pressed in order to notify the condition of the core filter, so as to ensure the proper replacement of the core filter if the core filter is not pressed tightly for providing optimum filtering operation.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is an exploded perspective view of a filter device incorporated with an intermediary element according to a preferred embodiment of the present invention, illustrating the screw connection of the first and second fasteners.

FIG. 2 is a perspective view of a core filter for the filter device according to the above preferred embodiment of the present invention.

FIG. 3 illustrates an alternative mode of the first and second fasteners of the filter device according to the above preferred embodiment of the present invention, illustrating the locking with plug and groove connection of the first and second fasteners.

FIG. 4 illustrates an alternative mode of the filter cover of the filter device according to the above preferred embodiment of the present invention, illustrating the tubing wall structure of the filter cover.

### DETAILED DESCRIPTION OF THE PREFERRED EMBODIMENT

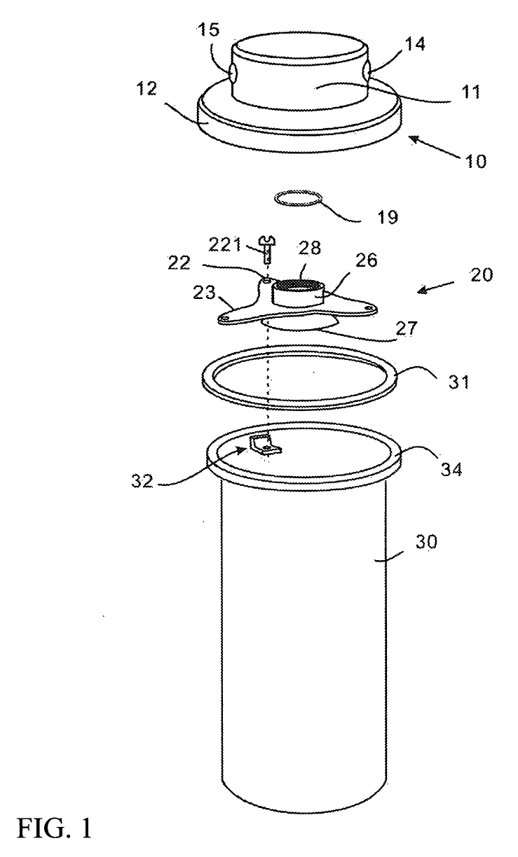

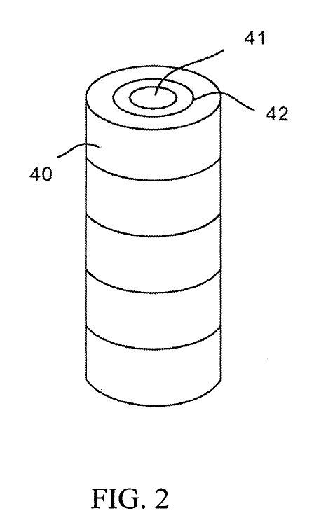

Referring to FIGS. 1 to 3 of the drawings, a method of connecting a filter cartridge 30 with a filter cover 10 by an intermediary element is illustrated, wherein the method comprises the following steps.

(1) Provide an intermediary element 20 comprising an upper filter retainer 25 at a lower portion of the intermediary element 20, an internal outlet connector 26 at an upper portion of the intermediary element 20, and a support 23, wherein the support 23 is integrally extended between the upper filter retainer 25 and the internal outlet connector 26 to form a one piece integrated structure. A fluid passage is formed and extended from the upper filter retainer 25 to the internal outlet connector 26.

(2) Provide one or more first fasteners 22 at the peripheral edge of the support 23 and one or more corresponding second fasteners 32 at an inner wall of the filter cartridge 30 at the upper opening portion thereof, wherein the first fasteners 22 and the second fasteners 32 are fastened with each other to firmly couple the intermediary element 20 at the filter cartridge 30 at a position that the retaining edge 27 of the upper filter retainer 25 is biased against an upper end 42 of a core filter 40 which is disposed in the filter cartridge 30.

(3) Configure a first threaded portion 28 at the outlet end of the internal outlet connector 26. In other words, the internal outlet connector 26 is configured to have a threaded outlet end.

(4) Configure an out-flowing passage 16 being extended from the filter cover 10 at a position that the out-flowing passage 16 is coaxially aligned with the outlet end of the internal outlet connector 26, wherein the out-flowing passage 16 has a second threaded portion 18 formed at the inlet end thereof to detachably engage with the first threaded portion at the outlet end of the internal outlet connector 26 so as to securely couple the filter cover 10 with the intermediary element 20. In other words, the out-flowing passage 16 is configured to have a corresponding threaded inlet end to detachably and rotatably couple with the threaded outlet end of the internal outlet connector 26. According to the preferred embodiment, the first and second threaded portions 28, 18 are inner and outer threaded portions. It is appreciated that the first and second threaded portions 28, 18 are outer and inner threaded portions that the outlet end of the internal outlet connector 26 can have the outer threaded portion to engage with the inner threaded portion of the out-flowing passage 16.

According to the preferred embodiment, the opposed end of the out-flowing passage 16 in the step 4 is integrally and downwardly extended from the cover body 11 of the filter cover 10 to communicate with an external outlet connector 14 provided thereat.

Preferably, the external outlet connector 14 further has a threaded structure or other connecting structures for external connection.

According to the preferred embodiment, the first fastener 22 and the second fastener 32 mentioned in the step 2 could be fastened by means of screwing with threaded structure, interlocking with plug and groove, or other coupling structures. It is appreciated that other similar structures should be included and protected in order to enable the engagement between the out-flowing passage 16 of the filter cover 10 and the outlet end of the internal outlet connector 26. Hence, any change, any modify or any amendment based on this invention could be deemed fallen into the protection scope of this invention.

As shown in FIGS. 1 to 3, the filter device comprises a filter cartridge 30 for receiving a core filter 40 therein, a filter cover 10, and an intermediary element 20 coupled between the filter cartridge 30 and the filter cover 10, wherein the intermediary element 20 forms an adapter to securely couple the filter cover 10 at the filter cartridge 30 for enclosing the core filter 40 therein. Accordingly, the intermediary element 20 comprises an upper filter retainer 25, an internal outlet connector 26 and a support 23, wherein a first threaded portion 28 is formed at the outlet end of the internal outlet connector 26.

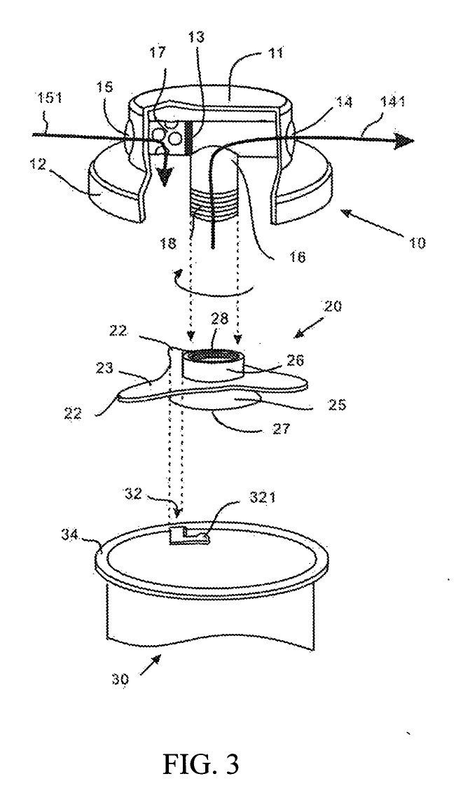

As illustrated in FIG. 3, an out-flowing passage 16 is integrally extended from the filter cover 10, wherein a second threaded portion 18 is formed at the inlet end of the out-flowing passage 16 to engage with the first threaded portion 28, so as to couple the out-flowing passage 16 with the internal outlet connector 26. In other words, the inlet end of the out-flowing passage 16 is coupled with the outlet end of the internal outlet connector 26 via the first and second threaded portions 28, 18.

The out-flowing passage 16 as illustrated in FIG. 3 is only an embodiment to implement this invention, and obviously other suitable means and designs could also be adopted. For example, a tube could be used to connect the second threaded portion 18 with an external outlet connector 14, and then the tube could be soldered to the filter cover 10 by strengthening ribs to enhance the mechanical strength.

It is preferred that the components of this invention are integrated by soldering.

The upper filter retainer 25, the internal outlet connector 26 and the support 23 are integrated, wherein a fluid flow passage is formed and extended from the upper filter retainer 25 to the internal outlet connector 26. Accordingly, when the intermediary element 20 couples between the filter cover 10 and the filter cartridge 30, the lower portion of the intermediary element 20, i.e. the upper filter retainer 25, presses against the core filter 40 to retain the core filter 40 in position, while the upper portion of the intermediary element 20, i.e. the internal outlet connector 26 is coupled with the filter cover 10 to communicate the out-flowing passage 16 with the internal outlet connector 26.

Accordingly, the core filter 40, which is embodied as a water purifying filter, has a central water purifying channel 41 to coaxially align and communicate with the internal outlet connector 26, wherein the purified water 141 is guided to flow from the water purifying channel 41 to the out-flowing passage 16 through the internal outlet connector 26 and is then discharged at the external outlet connector 14.

As illustrated in FIG. 3, the filter cover 10 further has a water inlet 15 for guiding an unpurified water 151, such as tap water or water before filtering, to flow into the filter cartridge 30 through the water inlet passage 17. In particular, the unpurified water 151 passes through the support 23 of the intermediary element 20 into the filter cartridge 30. Preferably, the support 23 has a star shape for enabling the unpurified water 151 flowing between two adjacent peripheral edge ends. In addition, a partition wall 13 is downwardly extended from the filter cover 10 at a position adjacent to the water inlet passage 17 for separating the unpurified water 151 and the purified water 141.

A plurality of first fasteners 22 are provided at the support 23 that the first fasteners 22 are provided at the peripheral edge ends of the support 23. Correspondingly, a plurality of second fasteners 32 are provided at the inner wall of the filter cartridge 30 at the upper opening portion thereof. The first fasteners 22 are detachably fastened with the second fasteners 32 to securely couple the intermediary element 20 with the filter cartridge 30.

It is worth mentioning that when the first and second fasteners 22, 32 are fastened with each other, the upper filter retainer 25 will automatically press against the upper end 42 of the core filter 40 so as to ensure the core filter 40 being retained within the filter cartridge 30.

The opposed end of the out-flowing passage 16 is integrated with the cover body 11 of the filter cover 10 to form an external outlet joint 14.

The first and second fasteners 22, 32 could be fastened by means of screwing, locking with plug and groove, or by any other suitable means, which will not be further mentioned here.

According to the preferred embodiment, the first and second threaded portions 28, 18 are inner and outer threaded portions. It is appreciated that the first and second threaded portions 28, 18 can be outer and inner threaded portions that the outlet end of the internal outlet connector 26 can have the outer threaded portion to engage with the inner threaded portion of the out-flowing passage 16. It is worth mentioning that when the upper and lower portions of the intermediary element 20 are securely coupled with the filter cover 10 and the filter cartridge 30 respectively, the filter cover 10 is securely coupled and communicated with the filter cartridge 30.

As shown in FIG. 1, the filter cartridge 30 has an upper sealing rim 34 to seal and couple with a sealing face of the sealing cover 12 of the filter cover 10 via a sealing ring 31. In other words, the sealing ring 31 is disposed between the sealing rim 34 of the filter cartridge 30 and the sealing face of the filter cover 10 to couple the filter cover 10 with the filter cartridge 30 in a water-tight manner. It is worth mentioning that when the first and second threaded portions 28, 18 are rotatably engaged with each other, the filter cover 10 is coupled with the filter cartridge 30 to further provide a sandwiching pressure to press and deform the sealing ring 31 to ensure the sealing effect of the sealing ring 31.

Meanwhile, the present invention further has a second sealing ring 19 to seal the engagement between the first and second threaded portions 28, 18 in a water-tight manner, when the first and second threaded portions 28, 18 are rotatably engaged with each other.

According to the preferred embodiment, as shown in FIG. 1, the first fastener 22 is a screw hole while the second fastener 32 is a latch with a corresponding screw hole. Therefore, when the screw hole of the first fastener 22 is aligned with the screw hole of the second fastener 32, a screw 221 is detachably fastened the first and second fasteners 22, 32 through the screw holes.

Alternatively, as shown in FIG. 3, the first fastener 22 is the peripheral edge of the support 23 while the second fastener 32 is a latch with a locking groove 321. Therefore, when the support 23 is disposed and rotated at the upper opening portion of the filter cartridge 30, the first fastener 22 is slid and locked at the locking groove 321 of the second fastener 32.

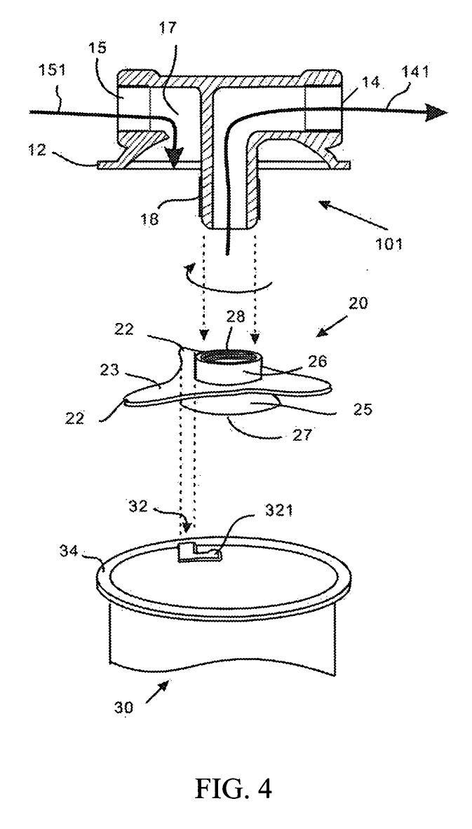

FIG. 4 illustrates an alternative mode of the present invention, which is slightly different from the above mentioned embodiment illustrated in FIG. 3. Instead of the cover body 11 in FIG. 3 enveloping the external outlet joint 14 and the water inlet 15 therein, the cover body 11 in FIG. 4 is integrated with the tubing walls of the external outlet joint 14 and the water inlet 15 to make the filter cover 10 having a compacted and firm construction.

The present invention could be used for filtering liquid such as water, or for filtering gas depending on the properties of the core filter.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of coupling a filter cover with a filter cartridge to enclose a core filter therewithin, comprising the steps of:
(a) providing an intermediary element which comprises an upper filter retainer, an internal outlet connector, and a support positioned between said upper filter retainer and said internal outlet connector, wherein a fluid passage is formed and is extended from the upper filter retainer to said internal outlet connector;
(b) providing one or more first fasteners at a peripheral edge of said support and one or more corresponding second fasteners at an inner wall of said filter cartridge at the upper opening portion thereof, wherein said first fasteners and said second fasteners are fastened with each other to firmly couple said intermediary element at said filter cartridge at a position that a retaining edge of said upper filter retainer is biased against an upper end of said core filter to retain said core filter in said filter cartridge;
(c) configuring a first threaded portion at an outlet end of said internal outlet connector; and
(d) configuring an out-flowing passage being extended from said filter cover at a position that said out-flowing passage is coaxially aligned with said outlet end of the internal outlet connector, wherein said out-flowing passage has a second threaded portion formed at an inlet end thereof to detachably engage with said first threaded portion at said outlet end of said internal outlet connector so as to securely couple said filter cover with said intermediary element.

2. The method, as recited in claim 1, wherein said first and second threaded portions are formed in threaded structure selected from the group consisting of said first and second threaded portions being configured as inner and outer threaded portions respectively, and said first and second threaded portions being configured as outer and inner threaded portions respectively.

3. The method as recited in claim 1 wherein, in the step (d), an opposed end of said out-flowing passage is integrated with said filter cover to form an external outlet joint.

4. The method as recited in claim 1 wherein, in the step (b), said first and second fasteners are selected from the group consisting of screw connection and locking with plug and groove connection.

5. A filter device, comprising a filter cartridge for receiving a core filter therein; a filter cover which comprises an out-flowing passage being extended from said filter cover; and an intermediary element for securely coupling said filter cover with said filter cartridge, wherein said intermediary element comprises:
an upper filter retainer,
an internal outlet connector,
a support positioned between said upper filter retainer and said internal outlet connector, wherein a fluid passage is formed and is extended from the upper filter retainer to said internal outlet connector;
one or more first fasteners provided at a peripheral edge of said support;
one or more corresponding second fasteners provided at an inner wall of said filter cartridge at the upper opening portion thereof, wherein said first fasteners and said second fasteners are fastened with each other to firmly couple said intermediary element at said filter cartridge for enclosing said core filter therein;
a first threaded portion provided at an outlet end of said internal outlet connector; and
a second threaded portion formed at an inlet end of said out-flowing passage, wherein said out-flowing passage is extended from said filter cover at a position that said out-flowing passage is coaxially aligned with said outlet end of the internal outlet connector, wherein said second threaded portion is detachably engage with said first threaded portion at said outlet end of said internal outlet connector to securely couple said filter cover with said intermediary element.

6. The filter device, as recited in claim 5, wherein said first fasteners and said second fasteners are fastened with each other to firmly couple said intermediary element at said filter cartridge at a position that a retaining edge of said upper filter retainer is biased against an upper end of said core filter to retain said core filter in said filter cartridge.

7. The filter device, as recited in claim 5, wherein an opposed end of said out-flowing passage is integrated with said filter cover to form an external outlet joint.

8. The filter device, as recited in claim 5, wherein said first and second fasteners are selected from the group consisting of screw connection and locking with plug and groove connection.

9. The filter device, as recited in claim 5, wherein said first and second threaded portions are formed in threaded structure selected from the group consisting of said first and second threaded portions being configured as inner and outer threaded portions respectively, and said first and second threaded portions being configured as outer and inner threaded portions respectively.
